(19) United States
(12) Patent Application Publication
(10) Pub. No.: US 2025/0317162 A1
(43) Pub. Date: Oct. 9, 2025

(54) TECHNOLOGIES FOR LID ANGLE ESTIMATION

(71) Applicant: Intel Corporation, Santa Clara, CA (US)

(72) Inventors: Qianjin Sheng, Shanghai (CN); Yan Lu, Shanghai (CN); Qing De Xia, Shanghai (CN)

(73) Assignee: Intel Corporation, Santa Clara, CA (US)

(21) Appl. No.: 18/866,007

(22) PCT Filed: Jun. 30, 2022
(86) PCT No.: PCT/CN2022/102788

§ 371 Date: Nov. 14, 2024

(51) Int. Cl. H04B 1/3827; G06F 1/16

(52) U.S. Cl. CPC H04B 1/3827; G06F 1/1677; G06F 1/1698

(57) ABSTRACT

Techniques for lid angle estimation are disclosed. In the illustrative embodiment, a compute device transmits a radiofrequency (RF) signal on an antenna. The compute device may then detect the RF signal on the same or a different antenna. The compute device can use a machine-learning-based algorithm to determine a lid angle based on the RF signal. The compute device may classify the lid angle as, e.g., a closed configuration, a laptop configuration, a tablet configuration, a book configuration, a tent configuration, etc.

### BACKGROUND

Clamshell-type devices with a base portion and a lid portion connected by a hinge often are able to sense the orientation of the base portion relative to the lid portion. Such an ability allows the device to respond to changes in the orientation of the lid portion, such as entering a low-power state when the lid is closed. The orientation of the lid portion relative to the base portion can be sensed using hinge sensors, such as resistive or capacitive contact sensors or magnetic-based sensors.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified drawing of at least one embodiment of a compute device for determining an angle of a lid relative to a base.

FIG. 2 is a simplified block diagram of at least one embodiment of the compute device of FIG. 1.

FIG. 3 is a simplified block diagram of at least one embodiment of an environment that may be established by the compute device of FIG. 1.

FIG. 4 is a simplified drawing of signal flows of the compute device of FIG. 1.

FIG. 5 is a simplified drawing of the compute device of FIG. 1 in a closed configuration.

FIG. 6 is a simplified drawing of the compute device of FIG. 1 in a laptop configuration.

FIG. 7 is a simplified drawing of the compute device of FIG. 1 in a tablet configuration.

FIG. 8 is a simplified drawing of the compute device of FIG. 1 in a flat configuration.

FIG. 9 is a simplified drawing of the compute device of FIG. 1 in a tent configuration.

FIG. 10 is a simplified flow diagram of at least one embodiment of a method for training a machine-learning-based algorithm to determine an angle of a lid relative to a base that may be executed by the compute device of FIG. 1.

FIG. 11 is a simplified flow diagram of at least one embodiment of a method for determining an angle of a lid relative to a base that may be executed by the compute device of FIG. 1.

### DETAILED DESCRIPTION OF THE DRAWINGS

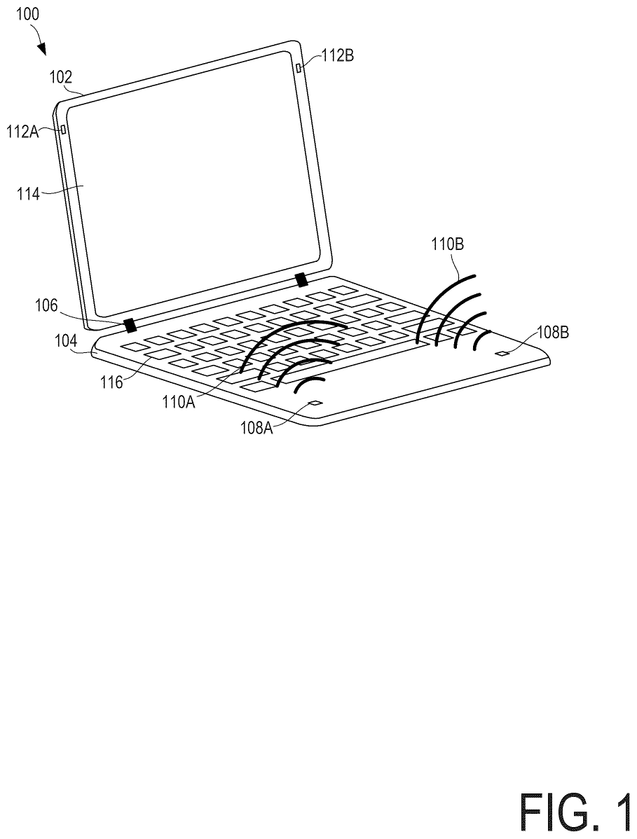

Referring to FIG. 1, in an illustrative embodiment, a compute device 100 has a lid portion 102 connected to a base portion 104 by a hinge 106. In use, in one embodiment, transmit antennas 108A and/or 108B can generate wireless radiofrequency (RF) signals 110A and/or 110B, respectively. Receive antennas 112A and/or 112B receive part of the RF signals 110A and/or 110B. As described in more detail below, the compute device 100 can use the RF signals reflected from the transmit antennas and/or the RF signals received on the receive antennas to determine the angle of the hinge 106 (i.e., the angle of the lid portion 102 and the base portion 104). In one embodiment, the position of nearby objects such as the lid portion 102 can change the impedance of the transmit antennas 108A and/or 108B, causing some of the transmitted signal to be reflected from the antennas 108A and/or 108B.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. Terms modified by the word “substantially” include arrangements, orientations, spacings, or positions that vary slightly from the meaning of the unmodified term. For example, a stereoscopic camera with a field of view of substantially 180 degrees includes cameras that have a field of view within a few degrees of 180 degrees.

The compute device 100 may be embodied as any type of compute device that has a lid portion 102 or similar housing and a base portion 104 or similar housing that can rotate relative to each other. For example, the compute device 100 may be embodied as or otherwise be included in, without limitation, a laptop computer, a notebook computer, a cellular phone, a smartphone, an e-reader, a tablet computer, a two-display device (e.g., with a display in the lid portion 102 and the base portion 104), a multiprocessor system, a processor-based system, a consumer electronic device, a wearable computer, a handset, a messaging device, a camera device, and/or any other compute device.

The illustrative lid portion 102 includes a display 114, and the illustrative base portion 104 includes a keyboard 116. It should be appreciated that, in some embodiments, both the lid portion 102 and the base portion 104 may have a different set of components. For example, in some embodiments, the lid portion 102 and the base portion 104 may each have a display 114, the base portion 104 may have a receive antenna 112 and the lid portion 102 may have a transmit antenna 108, etc. In some embodiments, the compute device 100 may not have a preferred orientation, making the labeling of one part of the compute device 100 the lid portion 102 and another part the base portion 104 arbitrary. The lid portion 102 may also be described as a housing 102, and the base portion 104 may also be described as a housing 104. It should be appreciated that either the housing 102 and/or the housing 104 may have a transmit antenna 108, receive antenna 112, display 114, keyboard 116, and/or any other suitable component.

In one embodiment, the compute device 100 includes one or more transmit antennas 108 and one or more receive antennas 112. In other embodiments, some or all of the antennas 108, 112 may be used for both transmit and receive. For example, in one embodiment, the compute device 100 may include one antenna for a particular protocol that is used as both a receive antenna 108 and transmit antenna 112.

The RF signals 110A, 110B transmitted and/or received by the compute device may be at any suitable frequency, such as 100 megahertz to 100 gigahertz. In some embodiments, the RF signals 110A, 110B may be embodied as microwave or millimeter-wave radiation.

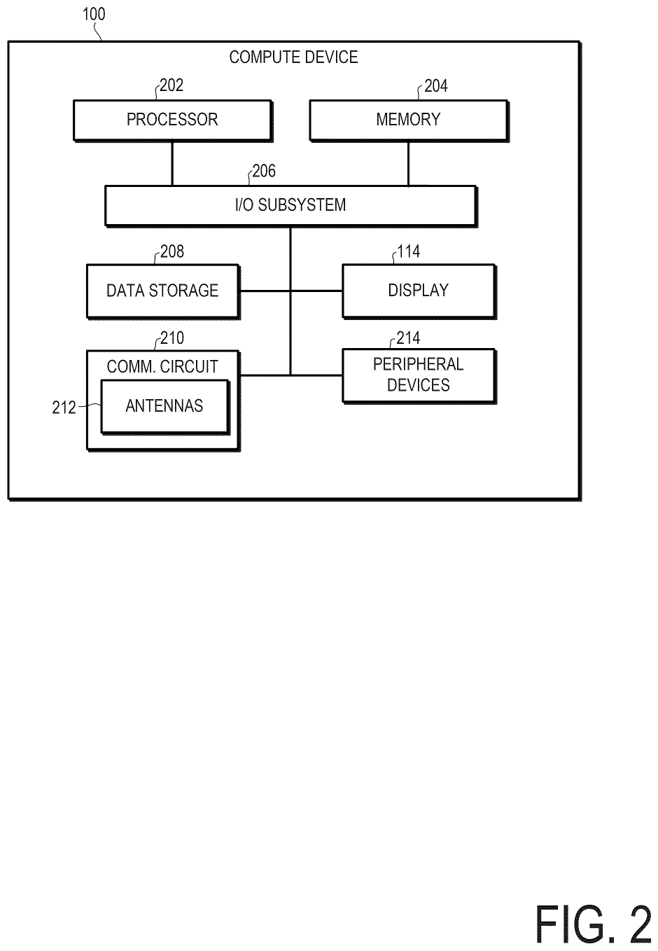

Referring now to FIG. 2, in one embodiment, a block diagram of the compute device 100 shows various components of the compute device 100. The illustrative compute device 100 includes one or more processors 202, a memory 204, an input/output (I/O) subsystem 206, data storage 208, a communication circuit 210, the display 114, and one or more peripheral devices 214. In some embodiments, one or more of the illustrative components of the compute device 100 may be incorporated in, or otherwise form a portion of, another component. For example, the memory 204, or portions thereof, may be incorporated in the processor 202 in some embodiments. In some embodiments, one or more of the illustrative components may be physically separated from another component.

The processor 202 may be embodied as any type of processor capable of performing the functions described herein. For example, the processor 202 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the compute device 100 such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the compute device 100. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 206 may connect various internal and external components of the compute device 100 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 206 may form a portion of a system-on-a-chip (SoC) and be incorporated, along with the processor 202, the memory 204, and other components of the compute device 100 on a single integrated circuit chip.

The data storage 208 may be embodied as any type of device or devices configured for the short-term or long-term storage of data. For example, the data storage 208 may include any one or more memory devices and circuits, memory cards, hard disk drives, solid-state drives, or other data storage devices.

The communication circuit 210 may be embodied as any type of interface capable of interfacing the compute device 100 with other compute devices, such as over one or more wired or wireless connections. In some embodiments, the communication circuit 210 may be capable of interfacing with any appropriate cable type, such as an electrical cable or an optical cable. The communication circuit 210 may be configured to use any one or more communication technology and associated protocols (e.g., Ethernet, Bluetooth®, Wi-Fi®, WiMAX, near field communication (NFC), 4G, 5G, etc.). The communication circuit 210 may be located on silicon separate from the processor 202, or the communication circuit 210 may be included in a multi-chip package with the processor 202, or even on the same die as the processor 202. The communication circuit 210 may be embodied as one or more add-in-boards, daughtercards, network interface cards, controller chips, chipsets, specialized components such as a field-programmable gate array (FPGA) or application-specific integrated circuit (ASIC), or other devices that may be used by the compute device 100 to connect with another compute device. In some embodiments, communication circuit 210 may be embodied as part of a system-on-a-chip (SoC) that includes one or more processors or may be included on a multichip package that also contains one or more processors. In some embodiments, the communication circuit 210 may include a local processor (not shown) and/or a local memory (not shown) that are both local to the communication circuit 210. In such embodiments, the local processor of the communication circuit 210 may be capable of performing one or more of the functions of the processor 202 described herein. Additionally or alternatively, in such embodiments, the local memory of the communication circuit 210 may be integrated into one or more components of the compute device 100 at the board level, socket level, chip level, and/or other levels. The communication circuit 210 may include one or more antennas 212. The antennas may be embodied as, e.g., transmit antennas 108 and/or receive antennas 112. In some embodiments, a single antenna 212 may be used as both a transmit antenna 108 and a receive antenna 112.

The display 114 may be embodied as any type of display on which information may be displayed to a user of the compute device 100, such as a touchscreen display, a liquid crystal display (LCD), a thin film transistor LCD (TFT-LCD), a light-emitting diode (LED) display, an organic light-emitting diode (OLED) display, a cathode ray tube (CRT) display, a plasma display, an image projector (e.g., 2D or 3D), a laser projector, a heads-up display, and/or other display technology.

In some embodiments, the compute device 100 may include other or additional components, such as those commonly found in a compute device. For example, the compute device 100 may also have peripheral devices 214, such as a keyboard, a mouse, an external storage device, etc. In some embodiments, the compute device 100 may be connected to a dock that can interface with various devices, including peripheral devices 214. In some embodiments, the peripheral devices 214 may include additional sensors that the compute device 100 can use to monitor the orientation of the lid portion 102 relative to the base portion 104, such as resistive or capacitive contact sensors or magnetic-based sensors.

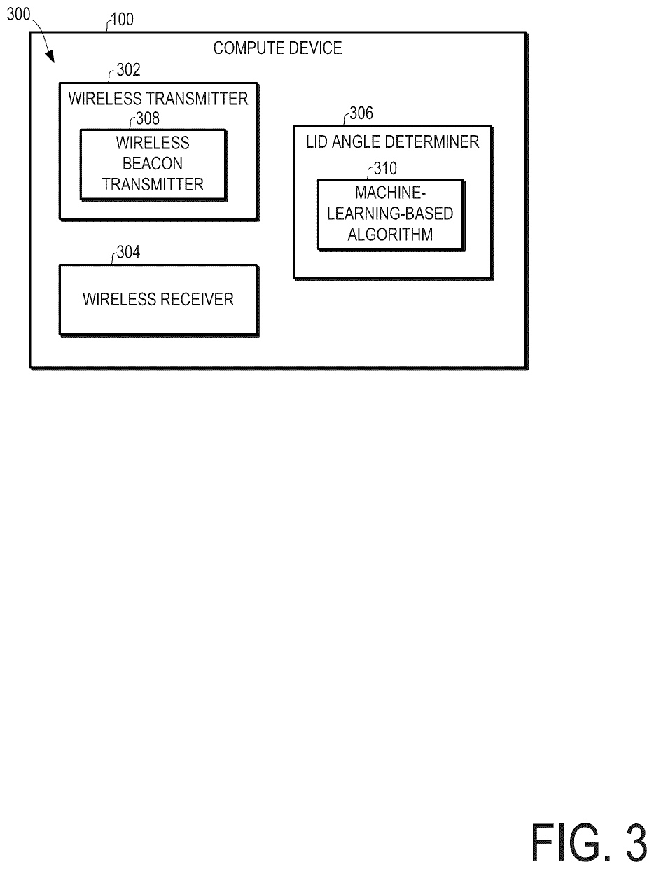

Referring now to FIG. 3, in an illustrative embodiment, the compute device 100 establishes an environment 300 during operation. The illustrative environment 300 includes a wireless transmitter 302, a wireless receiver 304, and a lid angle determiner 306. The various modules of the environment 300 may be embodied as hardware, software, firmware, or a combination thereof. For example, the various modules, logic, and other components of the environment 300 may form a portion of, or otherwise be established by, the processor 202, the memory 204, the data storage 208, or other hardware components of the compute device 100. As such, in some embodiments, one or more of the modules of the environment 300 may be embodied as circuitry or collection of electrical devices (e.g., wireless transmitter circuitry 302, wireless receiver circuitry 304, and lid angle determiner circuitry 306, etc.). It should be appreciated that, in such embodiments, one or more of the circuits (e.g., the wireless transmitter circuitry 302, the wireless receiver circuitry 304, and the lid angle determiner circuitry 306, etc.) may form a portion of one or more of the processor 202, the memory 204, the I/O subsystem 206, the data storage 208, and/or other components of the compute device 100. For example, in some embodiments, some or all of the modules may be embodied as the processor 202 as the memory 204 and/or data storage 208 storing instructions to be executed by the processor 202. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the processor 202 or other components of the compute device 100. It should be appreciated that some of the functionality of one or more of the modules of the environment 300 may require a hardware implementation, in which case embodiments of modules that implement such functionality will be embodied at least partially as hardware.

The wireless transmitter 302, which may be embodied as hardware, firmware, software, virtualized hardware, emulated architecture, and/or a combination thereof as discussed above, is configured to control transmission of wireless signals on the antennas 108A, 108B. As discussed above, in some embodiments, the one or more antennas 108 used for transmitting wireless signals may also be used for receiving wireless signals. In the illustrative embodiment, the wireless transmitter 302 transmits wireless signals as part of general wireless communication over, e.g., WiFi, Bluetooth, 4G, 5G, etc. Additionally or alternatively, in some embodiments, a wireless beacon transmitter 308 of the wireless transmitter 302 may transmit a wireless beacon on the antennas 108A, 108B. The wireless beacon may be any suitable signal that may be used to determine the lid angle. For example, the wireless beacon may be a pulse at a particular frequency, a pulse at a range of frequencies, or any other suitable RF signal. In some embodiments, any suitable wireless signal (including wireless signals sent as part of, e.g., WiFi communication) may be used to determine a lid angle. In such embodiments, as long as there has been recent wireless signals that can be used to determine the lid angle, the wireless beacon transmitter 308 does not need to transmit a wireless beacon. The wireless beacon transmitter 308 may then transmit wireless beacons if no wireless signal suitable for determining a lid angle has been sent in the past, e.g., 0.1-10 seconds.

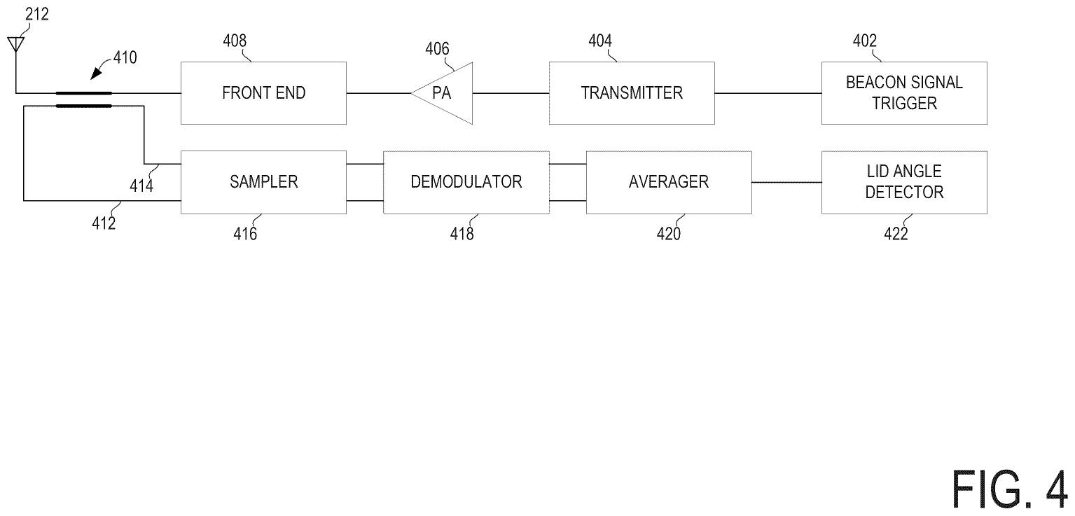

One representation of signal flows is shown in FIG. 4. A transmitter 404 generates signals to be sent on an antenna 212 (which may be, e.g., an antenna 108). When appropriate, a beacon signal trigger 402 may trigger the transmitter 404 to generate a signal. The signal from the transmitter 404 is sent to a power amplifier (PA) 406, which amplifies the signal. The signal is sent to a front end 408 and then to the antenna 212. In the illustrative embodiment, a bidirectional coupler 410 couples signals sent to and received (or reflected) from the antenna 212 onto signal lines 412, 414, described below in more detail in regard to the wireless receiver 304. In the illustrative embodiment, the wireless transmitter 302 may include any suitable components of the signal flow shown in FIG. 4, such as the beacon signal trigger 402, the transmitter 404, the power amplifier 406, and the front end 408.

The wireless receiver 304, which may be embodied as hardware, firmware, software, virtualized hardware, emulated architecture, and/or a combination thereof, as discussed above, is configured to receive signals from one or more antennas 108A, 108B, including transmit signals that are reflected from the one or more antennas 108A, 108B. As discussed above, in some embodiments, the one or more antennas 112 used for receiving wireless signals may also be used for transmitting wireless signals. The wireless receiver 304 may receive signals transmitted by the compute device 100 on the same or different antenna 112, or the wireless receiver 304 may receive signals transmitted by a remote device. The wireless receiver 304 may receive signals that are part of, e.g., WiFi communication, or the wireless receiver 304 may receive wireless beacons sent by the wireless beacon transmitter 308. The wireless receiver 304 may pre-process the signals, such as by demodulating them and determining parameters such as I/Q in-phase/quadrature components of the signal.

Returning to the signal flows shown in FIG. 4, in one embodiment, the bidirectional coupler 410 couples the signal transmitted to the antenna 212 onto line 412 and couples the signal received (or reflected) by the antenna 212 onto line 414. It should be appreciated that, in some embodiments, the wireless signal is influenced by the location and properties of objects in the vicinity of the antenna. The lid angle changes the relative position of the lid portion 102 and/or the base portion 104 relative to the antenna 212, which can affect wireless signals both from transmission and receiving perspectives. For example, the signal sent by the front end 408 to the antenna 212 may be partially reflected by the antenna 212 (e.g., due to impedance mismatch) onto the line 414. Similarly, a signal transmitted by the antenna 212 may be reflected by an object in the environment back onto the antenna 212 and onto the line 414. The signals on lines 412, 414 are sampled by a sampler 416 and demodulated by a demodulator 418. In some embodiments, the demodulator 418 may demodulate the analog signals on the lines 412, 414 using analog signal processing techniques. The demodulator 418 may determine parameters such I/Q in-phase/quadrature components of each of the signals on the lines 412, 414. The average 420 may determine an average value of the parameters such I/Q in-phase/quadrature components of each of the signals on the lines 412, 414. The parameters, ratios of the parameters, and/or the average of the parameters (and/or ratios of the parameters) may be sent to the lid angle detector 422. It should be appreciated that the data flow shown in FIG. 4 is merely one possible embodiment, and other embodiments may include fewer, more, or different components. For example, in one embodiment, there may be one or more filters or amplifiers in the lines 412, 414.

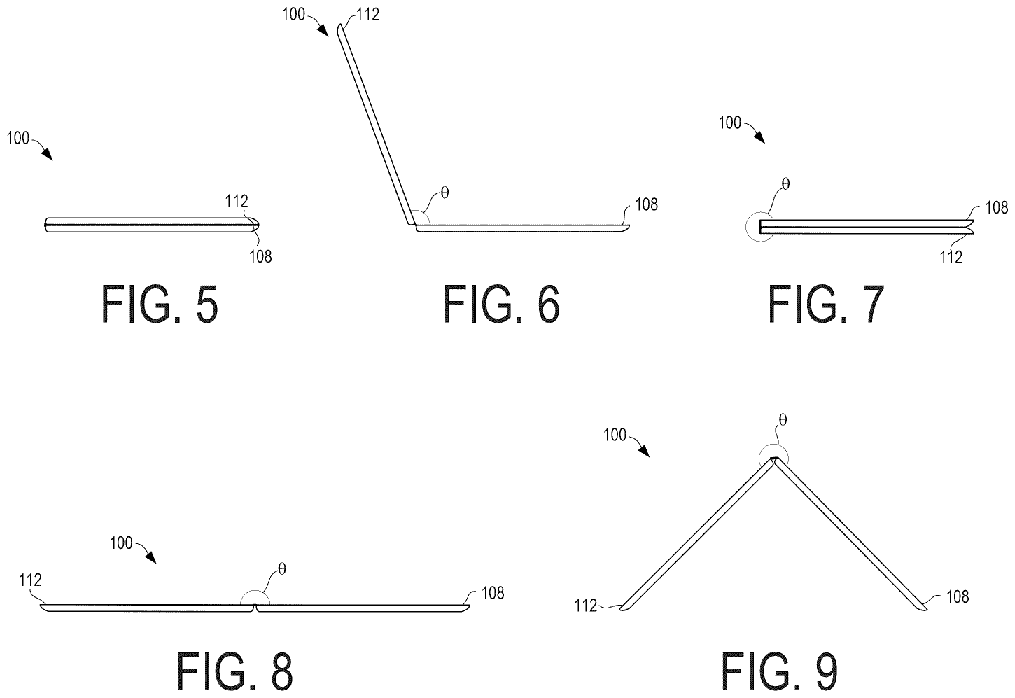

The lid angle determiner 306, which may be embodied as hardware, firmware, software, virtualized hardware, emulated architecture, and/or a combination thereof, as discussed above, is configured to determine an angle of the lid portion 102 relative to the base portion 104. To do so, the lid angle determiner 306 uses parameters such I/Q in-phase/quadrature components of signals that are sent and/or received on the antennas 212 (and/or the averages, ratios, etc., of I/Q in-phase/quadrature components). The lid angle determiner 306 may use any suitable technique in determining the lid angle, such as a machine-learning-based algorithm 310. The machine-learning-based algorithm 310 may employ any suitable machine-learning-based algorithm, such as a neural network. The machine-learning-based algorithm 310 may employ, e.g., scalar regression, multiclass classification, binary classification, etc. For example, in one embodiment, machine-learning-based algorithm 310 may determine a lid angle as a continuous angular value between 0 and 360 degrees. The compute device 100 may then classify lid angle into one of several configurations, such as those shown in FIGS. 5-9. FIG. 5 shows a compute device 100 in a closed configuration. FIG. 6 shows a compute device 100 in a laptop configuration. FIG. 7 shows a compute device 100 in a tablet configuration. FIG. 8 shows a compute device 100 in a flat configuration. FIG. 9 shows a compute device 100 in a tent configuration. The compute device 100 may classify an angle of 0-30° as being in the closed configuration, an angle of 30-150° as being in the laptop configuration, an angle of 150-200° as being in the flat configuration, an angle of 200-330° as being in the tent configuration, and an angle of 330-360° as being in the tablet configuration. In another embodiment, the machine-learning-based algorithm 310 may use the machine-learning-based algorithm 310 to directly classify the lid angle as corresponding to one the configurations shown in FIGS. 5-9. In yet another embodiment, the machine-learning-based algorithm 310 may classify the lid angle as corresponding to one of two configurations, such as open or closed.

After determining the lid angle, the lid angle determiner 306 may take suitable action, such as transitioning to a sleep mode when the compute device 100 is changed to a closed configuration, waking up when the compute device 100 is changed out of a closed configuration, changing to a tablet mode when the compute device 100 is changed to a tablet configuration, etc. The compute device 100 may also provide lid angle information as context to various applications or usage scenarios. For example, the compute device 100 may adjust display illumination based on the lid angle, may use the lid angle to help face identification to determine the face angle for quick login/logout authentication, may help camera applications to activate/deactivate user sensing, etc.

In the illustrative embodiment, the lid angle determiner 306 trains the machine-learning-based algorithm 310. The lid angle determiner 306 uses labeled training data to train the machine-learning-based algorithm 310 and evaluate the machine-learning-based algorithm 310. The lid angle determiner 306 may then store parameters of the machine-learning-based algorithm 310 for later use. It should be appreciated that, in general, the compute device 100 does not need to train the machine-learning-based algorithm 310 itself. Rather, the compute device 100 may have parameters for the machine-learning-based algorithm 310 stored in the compute device 100 that the machine-learning-based algorithm 310 can access when necessary.

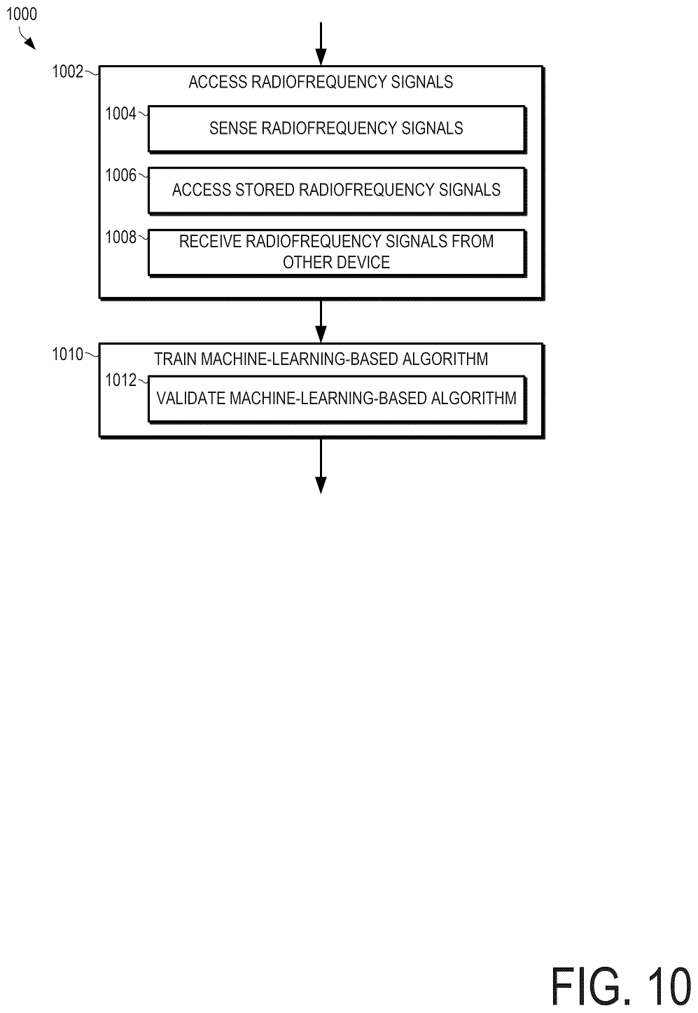

Referring now to FIG. 10, in use, the compute device 100 may execute a method 1000 for training a machine-learning-based algorithm to determine an angle between a lid portion 102 and a base portion 104 of the compute device 100. The method 1000 begins in block 1002, in which the compute device 100 accesses RF signals. The compute device 100 may sense the RF signals itself in block 1004. Additionally or alternatively, in some embodiments, the compute device 100 may access RF signals stored in the compute device 100 in block 1006 and/or may receive RF signals from another device in block 1008.

In block 1010, the compute device 100 trains the machine-learning-based algorithm. The compute device 100 may train for, e.g., scalar regression, multiclass classification, binary classification, etc. The compute device 100 may validate the machine-learning-based algorithm in block 1012, such as by using some training data samples not used to train the machine-learning-based algorithm.

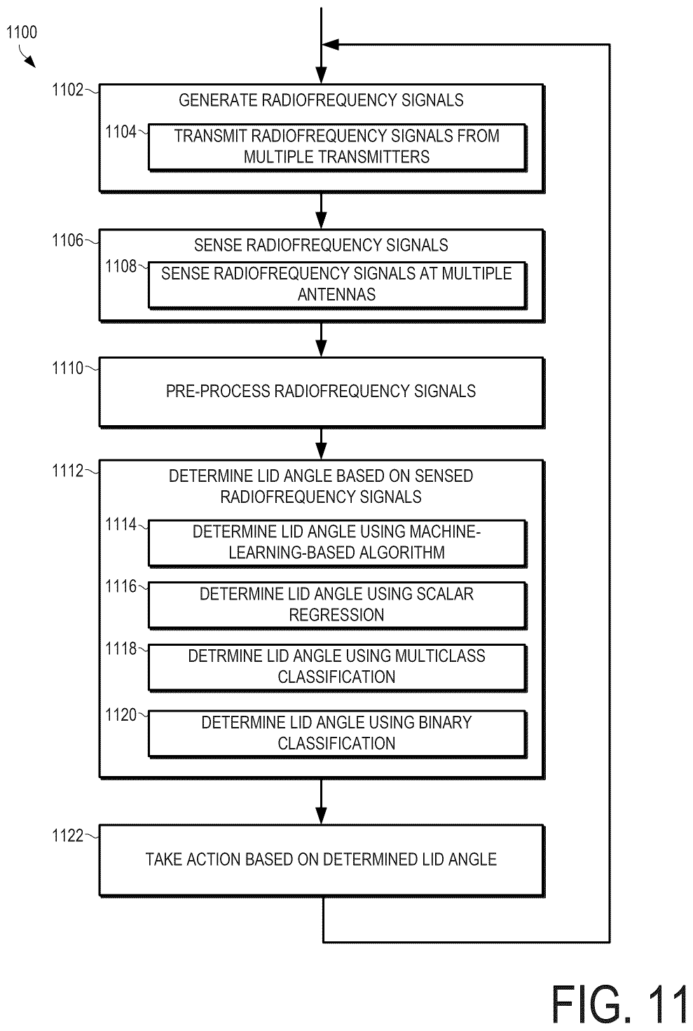

Referring now to FIG. 11, in use, the compute device 100 may execute a method 1100 for determining an angle between a lid portion 102 and a base portion 104 of the compute device 100. The method 1100 begins in block 1102, in which the compute device 100 generates RF signals on one or more antennas 108. The compute device 100 may generate any suitable RF signal, such as an RF signal with any suitable combination of one or more frequencies that may have a particular phase or timing relation, a chirped RF pulse, etc. The compute device 100 may generate RF signals as part of wireless communication that is already happening independently of determining an angle of the lid, such as WiFi or Bluetooth communication. In some embodiments, if there has not been adequate wireless communication to determine an angle of the lid, the compute device 100 may send a wireless beacon for the purpose of determining an angle of the lid.

In block 1106, the compute device 100 senses the RF signal generated in block 1102 at an antenna 112 or 108. In some embodiments, the compute device 100 may sense the RF signal using the same antenna that is used to transmit the RF signal. The compute device 100 may sense the RF signal as it is being transmitted (e.g., reflected from the antenna) or received. In block 1108, in some embodiments, the compute device 100 senses an RF signal at multiple antennas 112 or 108.

In block 1110, the compute device 100 preprocesses the RF signals. For example, the compute device 100 may apply one or more filters, amplifiers, samplers, digital or analog demodulators, etc. In the illustrative embodiment, the compute device 100 determines an I/Q in-phase/quadrature values of the RF signal. The compute device 100 may determine I/Q in-phase/quadrature values both for signals sent and received on an antenna. The compute device 100 may also determine, e.g., average I/Q values or ratios of I/Q values (e.g., ratios of signals sent on an antenna to signals received or reflected on the antenna).

In block 1112, the compute device 100 determines a lid angle using the sensed RF signals. In block 1114, the compute device 100 determines the lid angle using a machine-learning-based algorithm, such as a neural network. In block 1116, the compute device 100 may determine a lid angle using scalar regression. In block 1118, the compute device 100 may determine a lid angle using multiclass classification. In block 1120, the compute device 100 may determine a lid angle using binary classification. In some embodiments, the compute device 100 may determine an indication of a lid angle, such as a result of a multiclass classification, without explicitly determining the lid angle as a numerical value.

In block 1122, the compute device 100 may take an action based on the determined lid angle. For example, the compute device 100 may transition to a sleep mode when the compute device 100 is changed to a closed configuration, the compute device 100 may wake up when the compute device 100 is changed out of a closed configuration, the compute device 100 may change to a tablet mode when the compute device 100 is changed to a tablet configuration, etc.

### EXAMPLES

Illustrative examples of the technologies disclosed herein are provided below. An embodiment of the technologies may include any one or more, and any combination of, the examples described below.

Example 1 includes a compute device comprising a lid portion; a base portion; a hinge by which the lid portion and base portion are rotatably coupled; an antenna; wireless receiver circuitry to receive a radiofrequency (RF) signal from the antenna; and lid angle determiner circuitry to determine one or more parameters based on the RF signal; and determine, based on the one or more parameters, an indication of an angle of the lid portion relative to the base portion.

Example 2 includes the subject matter of Example 1, and further including wireless transmitter circuitry to transmit the RF signal before receipt of the RF signal.

Example 3 includes the subject matter of any of Examples 1 and 2, and wherein to transmit the RF signal comprises to transmit the RF signal on the antenna.

Example 4 includes the subject matter of any of Examples 1-3, and wherein to transmit the RF signal comprises to transmit the RF signal on a second antenna different from the antenna.

Example 5 includes the subject matter of any of Examples 1-4, and wherein to transmit the RF signal comprises to transmit the RF signal as part of wireless communication with a remote device.

Example 6 includes the subject matter of any of Examples 1-5, and wherein the wireless receiver circuitry is further to measure the transmitted RF signal, wherein the lid angle determiner circuitry is further to determine one or more additional parameters based on the measured transmitted RF signal, wherein to determine the indication of the angle of the lid portion relative to the base portion comprises to determine, based on the one or more parameters and the one or more additional parameters, the indication of the angle of the lid portion relative to the base portion.

Example 7 includes the subject matter of any of Examples 1-6, and wherein the compute device comprises a bi-directional coupler coupled to the antenna, wherein to receive the RF signal from the antenna comprises to receive, by the bi-directional coupler, a reflection of the transmitted RF signal from the antenna, wherein to measure the transmitted RF signal comprises to couple the transmitted RF signal to the bi-directional coupler.

Example 8 includes the subject matter of any of Examples 1-7, and further including wireless transmitter circuitry to send a wireless beacon, wherein to receive the RF signal from the antenna comprises to receive the wireless beacon.

Example 9 includes the subject matter of any of Examples 1-8, and wherein to send the wireless beacon comprises to determine that a wireless signal suitable for determination of the indication of the angle of the lid portion has not been sent in a previous threshold amount of time.

Example 10 includes the subject matter of any of Examples 1-9, and wherein to determine the one or more parameters based on the RF signal comprises to demodulate the RF signal, wherein the one or more parameters comprise an in-phase and quadrature component of the demodulated RF signal.

Example 11 includes the subject matter of any of Examples 1-10, and further including wireless transmitter circuitry to transmit the RF signal before receipt of the RF signal, wherein the wireless receiver circuity is to measure transmitted RF signal, wherein the lid angle determiner circuitry is to determine one or more additional parameters based on the measured transmitted RF signal, wherein to determine the indication of the angle of the lid portion relative to the base portion comprises to determine, based on the one or more parameters and the one or more additional parameters, the indication of the angle of the lid portion relative to the base portion, wherein to determine the one or more additional parameters based on the measured transmitted RF signal comprises to demodulate the measured transmitted RF signal, wherein the one or more parameters comprise an in-phase and quadrature component of the demodulated measured transmitted RF signal.

Example 12 includes the subject matter of any of Examples 1-11, and wherein the one or more parameters comprise a ratio of an amplitude of the demodulated RF signal to an amplitude of the demodulated measured transmitted RF signal.

Example 13 includes the subject matter of any of Examples 1-12, and wherein the one or more parameters comprise an average of the in-phase component of the demodulated RF signal and an average of the quadrature component of the demodulated RF signal.

Example 14 includes the subject matter of any of Examples 1-13, and wherein to determine the indication of the angle of the lid portion relative to the base portion comprises to determine, with use of a machine-learning-based algorithm, the indication of the angle of the lid portion relative to the base portion.

Example 15 includes the subject matter of any of Examples 1-14, and wherein the machine-learning-based algorithm is a neural network.

Example 16 includes the subject matter of any of Examples 1-15, and wherein the indication of the angle of the lid portion relative to the base portion is an estimate of the angle of the lid portion relative to the base portion.

Example 17 includes the subject matter of any of Examples 1-16, and wherein the lid angle determiner circuitry is further to classify the compute device into one of a plurality of classes based on the estimate of the angle of the lid portion relative to the base portion.

Example 18 includes the subject matter of any of Examples 1-17, and wherein the plurality of classes comprises a closed configuration, a laptop configuration, a tablet configuration, a flat configuration, and a tent configuration.

Example 19 includes the subject matter of any of Examples 1-18, and wherein to determine, with use of the machine-learning-based algorithm, the indication of the angle of the lid portion relative to the base portion comprises to classify the angle of the lid portion relative to the base portion into one of a plurality of classes.

Example 20 includes the subject matter of any of Examples 1-19, and wherein the plurality of classes comprises a closed configuration, a laptop configuration, a tablet configuration, a flat configuration, and a tent configuration.

Example 21 includes the subject matter of any of Examples 1-20, and wherein to determine, with use of the machine-learning-based algorithm, the indication of the angle of the lid portion relative to the base portion comprises to classify the angle of the lid portion relative to the base portion into one of two classes, wherein the two classes comprise an open configuration and a closed configuration.

Example 22 includes the subject matter of any of Examples 1-21, and wherein the machine-learning-based algorithm requires less than 10 kilobytes of storage space.

Example 23 includes the subject matter of any of Examples 1-22, and wherein the machine-learning-based algorithm requires less than 2,000 floating point operations to determine the indication of the angle of the lid portion relative to the base portion.

Example 24 includes the subject matter of any of Examples 1-23, and wherein the RF signal has a frequency between 100 megahertz and 60 gigahertz.

Example 25 includes the subject matter of any of Examples 1-24, and wherein the lid portion is able to rotate substantially 360° relative to the base portion.

Example 26 includes a method comprising receiving, by a compute device, a radiofrequency (RF) signal from an antenna of the compute device, wherein the compute device comprises a lid portion and a base portion; determining, by the compute device, one or more parameters based on the RF signal; and determining, by the compute device and based on the one or more parameters, an indication of an angle of the lid portion relative to the base portion.

Example 27 includes the subject matter of Example 26, and further including transmitting, by the compute device, the RF signal before receipt of the RF signal.

Example 28 includes the subject matter of any of Examples 26 and 27, and wherein transmitting the RF signal comprises transmitting the RF signal on the antenna.

Example 29 includes the subject matter of any of Examples 26-28, and wherein transmitting the RF signal comprises transmitting the RF signal on a second antenna different from the antenna.

Example 30 includes the subject matter of any of Examples 26-29, and wherein transmitting, by the compute device, the RF signal comprises transmitting the RF signal as part of wireless communication with a remote device.

Example 31 includes the subject matter of any of Examples 26-30, and further including measuring, by the compute device, the transmitted RF signal; and determining, by the compute device, one or more additional parameters based on the measured transmitted RF signal, wherein determining the indication of the angle of the lid portion relative to the base portion comprises determining, based on the one or more parameters and the one or more additional parameters, the indication of the angle of the lid portion relative to the base portion.

Example 32 includes the subject matter of any of Examples 26-31, and wherein the compute device comprises a bi-directional coupler coupled to the antenna, wherein receiving the RF signal from the antenna comprises receiving, by the bi-directional coupler, a reflection of the transmitted RF signal from the antenna, wherein measuring the transmitted RF signal comprises coupling the transmitted RF signal to the bi-directional coupler.

Example 33 includes the subject matter of any of Examples 26-32, and further including sending, by the compute device, a wireless beacon, wherein receiving the RF signal from the antenna comprises receiving the wireless beacon.

Example 34 includes the subject matter of any of Examples 26-33, and wherein sending the wireless beacon comprises determining that a wireless signal suitable for determination of the indication of the angle of the lid portion has not been sent in a previous threshold amount of time.

Example 35 includes the subject matter of any of Examples 26-34, and wherein determining the one or more parameters based on the RF signal comprises demodulating the RF signal, wherein the one or more parameters comprise an in-phase and quadrature component of the demodulated RF signal.

Example 36 includes the subject matter of any of Examples 26-35, and further including transmitting, by the compute device, the RF signal before receipt of the RF signal; measuring, by the compute device, transmitted RF signal; and determining, by the compute device, one or more additional parameters based on the measured transmitted RF signal, wherein determining the indication of the angle of the lid portion relative to the base portion comprises determining, based on the one or more parameters and the one or more additional parameters, the indication of the angle of the lid portion relative to the base portion, wherein determining the one or more additional parameters based on the measured transmitted RF signal comprises demodulating the measured transmitted RF signal, wherein the one or more parameters comprise an in-phase and quadrature component of the demodulated measured transmitted RF signal.

Example 37 includes the subject matter of any of Examples 26-36, and wherein the one or more parameters comprise a ratio of an amplitude of the demodulated RF signal to an amplitude of the demodulated measured transmitted RF signal.

Example 38 includes the subject matter of any of Examples 26-37, and wherein the one or more parameters comprise an average of the in-phase component of the demodulated RF signal and an average of the quadrature component of the demodulated RF signal.

Example 39 includes the subject matter of any of Examples 26-38, and wherein determining the indication of the angle of the lid portion relative to the base portion comprises determining, with use of a machine-learning-based algorithm, the indication of the angle of the lid portion relative to the base portion.

Example 40 includes the subject matter of any of Examples 26-39, and wherein the machine-learning-based algorithm is a neural network.

Example 41 includes the subject matter of any of Examples 26-40, and wherein the indication of the angle of the lid portion relative to the base portion is an estimate of the angle of the lid portion relative to the base portion.

Example 42 includes the subject matter of any of Examples 26-41, and further including classifying the compute device into one of a plurality of classes based on the estimate of the angle of the lid portion relative to the base portion.

Example 43 includes the subject matter of any of Examples 26-42, and wherein the plurality of classes comprises a closed configuration, a laptop configuration, a tablet configuration, a flat configuration, and a tent configuration.

Example 44 includes the subject matter of any of Examples 26-43, and wherein determining, with use of the machine-learning-based algorithm, the indication of the angle of the lid portion relative to the base portion comprises classifying the angle of the lid portion relative to the base portion into one of a plurality of classes.

Example 45 includes the subject matter of any of Examples 26-44, and wherein the plurality of classes comprises a closed configuration, a laptop configuration, a tablet configuration, a flat configuration, and a tent configuration.

Example 46 includes the subject matter of any of Examples 26-45, and wherein determining, with use of the machine-learning-based algorithm, the indication of the angle of the lid portion relative to the base portion comprises classifying the angle of the lid portion relative to the base portion into one of two classes, wherein the two classes comprise an open configuration and a closed configuration.

Example 47 includes the subject matter of any of Examples 26-46, and wherein the machine-learning-based algorithm requires less than 10 kilobytes of storage space.

Example 48 includes the subject matter of any of Examples 26-47, and wherein the machine-learning-based algorithm requires less than 2,000 floating point operations to determine the indication of the angle of the lid portion relative to the base portion.

Example 49 includes the subject matter of any of Examples 26-48, and wherein the RF signal has a frequency between 100 megahertz and 60 gigahertz.

Example 50 includes the subject matter of any of Examples 26-49, and wherein the lid portion is able to rotate substantially 360° relative to the base portion.

Example 51 includes a compute device comprising means for receiving a radiofrequency (RF) signal from an antenna of the compute device, wherein the compute device comprises a lid portion and a base portion; means for determining one or more parameters based on the RF signal; and means for determining, based on the one or more parameters, an indication of an angle of the lid portion relative to the base portion.

Example 52 includes the subject matter of Example 51, and further including means for transmitting the RF signal before receipt of the RF signal.

Example 53 includes the subject matter of any of Examples 51 and 52, and further including means for measuring the transmitted RF signal; and means for determining one or more additional parameters based on the measured transmitted RF signal, wherein the means for determining the indication of the angle of the lid portion relative to the base portion comprises means for determining, based on the one or more parameters and the one or more additional parameters, the indication of the angle of the lid portion relative to the base portion.

Example 54 includes the subject matter of any of Examples 51-53, and wherein the means for determining the one or more parameters based on the RF signal comprises means for demodulating the RF signal, wherein the one or more parameters comprise an in-phase and quadrature component of the demodulated RF signal.

Example 55 includes the subject matter of any of Examples 51-54, and further including means for transmitting the RF signal before receipt of the RF signal; means for measuring transmitted RF signal; and means for determining one or more additional parameters based on the measured transmitted RF signal, wherein the means for determining the indication of the angle of the lid portion relative to the base portion comprises means for determining, based on the one or more parameters and the one or more additional parameters, the indication of the angle of the lid portion relative to the base portion, wherein the means for determining the one or more additional parameters based on the measured transmitted RF signal comprises means for demodulating the measured transmitted RF signal, wherein the one or more parameters comprise an in-phase and quadrature component of the demodulated measured transmitted RF signal.

Example 56 includes the subject matter of any of Examples 51-55, and wherein the one or more parameters comprise a ratio of an amplitude of the demodulated RF signal to an amplitude of the demodulated measured transmitted RF signal.

Example 57 includes the subject matter of any of Examples 51-56, and wherein the one or more parameters comprise an average of the in-phase component of the demodulated RF signal and an average of the quadrature component of the demodulated RF signal.

Example 58 includes the subject matter of any of Examples 51-57, and wherein the means for determining the indication of the angle of the lid portion relative to the base portion comprises means for determining, with use of a machine-learning-based algorithm, the indication of the angle of the lid portion relative to the base portion.

Example 59 includes the subject matter of any of Examples 51-58, and wherein the machine-learning-based algorithm is a neural network.

Example 60 includes the subject matter of any of Examples 51-59, and wherein the indication of the angle of the lid portion relative to the base portion is an estimate of the angle of the lid portion relative to the base portion.

Example 61 includes the subject matter of any of Examples 51-60, and further including means for classifying the compute device into one of a plurality of classes based on the estimate of the angle of the lid portion relative to the base portion.

Example 62 includes the subject matter of any of Examples 51-61, and wherein the plurality of classes comprises a closed configuration, a laptop configuration, a tablet configuration, a flat configuration, and a tent configuration.

Example 63 includes the subject matter of any of Examples 51-62, and wherein the means for determining, with use of the machine-learning-based algorithm, the indication of the angle of the lid portion relative to the base portion comprises means for classifying the angle of the lid portion relative to the base portion into one of a plurality of classes.

Example 64 includes the subject matter of any of Examples 51-63, and wherein the plurality of classes comprises a closed configuration, a laptop configuration, a tablet configuration, a flat configuration, and a tent configuration.

Example 65 includes the subject matter of any of Examples 51-64, and wherein the means for determining, with use of the machine-learning-based algorithm, the indication of the angle of the lid portion relative to the base portion comprises means for classifying the angle of the lid portion relative to the base portion into one of two classes, wherein the two classes comprise an open configuration and a closed configuration.

Example 66 includes the subject matter of any of Examples 51-65, and wherein the machine-learning-based algorithm requires less than 10 kilobytes of storage space.

Example 67 includes the subject matter of any of Examples 51-66, and wherein the machine-learning-based algorithm requires less than 2,000 floating point operations to determine the indication of the angle of the lid portion relative to the base portion.

Example 68 includes the subject matter of any of Examples 51-67, and wherein the RF signal has a frequency between 100 megahertz and 60 gigahertz.

Example 69 includes the subject matter of any of Examples 51-68, and wherein the lid portion is able to rotate substantially 360° relative to the base portion.

Example 70 includes one or more computer-readable media comprising a plurality of instructions stored thereon that, when executed, causes a compute device to receive a radiofrequency (RF) signal from an antenna of the compute device; determine one or more parameters based on the RF signal; and determine, based on the one or more parameters, an indication of an angle of a lid portion of the compute device relative to a base portion of the compute device.

Example 71 includes the subject matter of Example 70, and wherein the plurality of instructions further cause the compute device to transmit the RF signal before receipt of the RF signal.

Example 72 includes the subject matter of any of Examples 70 and 71, and wherein to transmit the RF signal comprises to transmit the RF signal on the antenna.

Example 73 includes the subject matter of any of Examples 70-72, and wherein to transmit the RF signal comprises to transmit the RF signal on a second antenna different from the antenna.

Example 74 includes the subject matter of any of Examples 70-73, and wherein to transmit the RF signal comprises to transmit the RF signal as part of wireless communication with a remote device.

Example 75 includes the subject matter of any of Examples 70-74, and wherein the plurality of instructions further causes the compute device to measure the transmitted RF signal, wherein the plurality of instructions further causes the compute device to determine one or more additional parameters based on the measured transmitted RF signal, wherein to determine the indication of the angle of the lid portion relative to the base portion comprises to determine, based on the one or more parameters and the one or more additional parameters, the indication of the angle of the lid portion relative to the base portion.

Example 76 includes the subject matter of any of Examples 70-75, and wherein the compute device comprises a bi-directional coupler coupled to the antenna, wherein to receive the RF signal from the antenna comprises to receive, by the bi-directional coupler, a reflection of the transmitted RF signal from the antenna, wherein to measure the transmitted RF signal comprises to couple the transmitted RF signal to the bi-directional coupler.

Example 77 includes the subject matter of any of Examples 70-76, and wherein the plurality of instructions further cause the compute device to send a wireless beacon, wherein to receive the RF signal from the antenna comprises to receive the wireless beacon.

Example 78 includes the subject matter of any of Examples 70-77, and wherein to send the wireless beacon comprises to determine that a wireless signal suitable for determination of the indication of the angle of the lid portion has not been sent in a previous threshold amount of time.

Example 79 includes the subject matter of any of Examples 70-78, and wherein to determine the one or more parameters based on the RF signal comprises to demodulate the RF signal, wherein the one or more parameters comprise an in-phase and quadrature component of the demodulated RF signal.

Example 80 includes the subject matter of any of Examples 70-79, and wherein the plurality of instructions further cause the compute device to transmit the RF signal before receipt of the RF signal; measure transmitted RF signal; and determine one or more additional parameters based on the measured transmitted RF signal, wherein to determine the indication of the angle of the lid portion relative to the base portion comprises to determine, based on the one or more parameters and the one or more additional parameters, the indication of the angle of the lid portion relative to the base portion, wherein to determine the one or more additional parameters based on the measured transmitted RF signal comprises to demodulate the measured transmitted RF signal, wherein the one or more parameters comprise an in-phase and quadrature component of the demodulated measured transmitted RF signal.

Example 81 includes the subject matter of any of Examples 70-80, and wherein the one or more parameters comprise a ratio of an amplitude of the demodulated RF signal to an amplitude of the demodulated measured transmitted RF signal.

Example 82 includes the subject matter of any of Examples 70-81, and wherein the one or more parameters comprise an average of the in-phase component of the demodulated RF signal and an average of the quadrature component of the demodulated RF signal.

Example 83 includes the subject matter of any of Examples 70-82, and wherein to determine the indication of the angle of the lid portion relative to the base portion comprises to determine, with use of a machine-learning-based algorithm, the indication of the angle of the lid portion relative to the base portion.

Example 84 includes the subject matter of any of Examples 70-83, and wherein the machine-learning-based algorithm is a neural network.

Example 85 includes the subject matter of any of Examples 70-84, and wherein the indication of the angle of the lid portion relative to the base portion is an estimate of the angle of the lid portion relative to the base portion.

Example 86 includes the subject matter of any of Examples 70-85, and wherein the plurality of instructions further causes the compute device to classify the compute device into one of a plurality of classes based on the estimate of the angle of the lid portion relative to the base portion.

Example 87 includes the subject matter of any of Examples 70-86, and wherein the plurality of classes comprises a closed configuration, a laptop configuration, a tablet configuration, a flat configuration, and a tent configuration.

Example 88 includes the subject matter of any of Examples 70-87, and wherein to determine, with use of the machine-learning-based algorithm, the indication of the angle of the lid portion relative to the base portion comprises to classify the angle of the lid portion relative to the base portion into one of a plurality of classes.

Example 89 includes the subject matter of any of Examples 70-88, and wherein the plurality of classes comprises a closed configuration, a laptop configuration, a tablet configuration, a flat configuration, and a tent configuration.

Example 90 includes the subject matter of any of Examples 70-89, and wherein to determine, with use of the machine-learning-based algorithm, the indication of the angle of the lid portion relative to the base portion comprises to classify the angle of the lid portion relative to the base portion into one of two classes, wherein the two classes comprise an open configuration and a closed configuration.

Example 91 includes the subject matter of any of Examples 70-90, and wherein the machine-learning-based algorithm requires less than 10 kilobytes of storage space.

Example 92 includes the subject matter of any of Examples 70-91, and wherein the machine-learning-based algorithm requires less than 2,000 floating point operations to determine the indication of the angle of the lid portion relative to the base portion.

Example 93 includes the subject matter of any of Examples 70-92, and wherein the RF signal has a frequency between 100 megahertz and 60 gigahertz.

Example 94 includes the subject matter of any of Examples 70-93, and wherein the lid portion is able to rotate substantially 360° relative to the base portion.

1-25. (canceled)

26. A compute device comprising:
a lid portion;
a base portion;
a hinge by which the lid portion and base portion are rotatably coupled;
an antenna;
wireless receiver circuitry to receive a radiofrequency (RF) signal from the antenna; and
lid angle determiner circuitry to:
determine one or more parameters based on the RF signal; and
determine, based on the one or more parameters, an indication of an angle of the lid portion relative to the base portion.

27. The compute device of claim 26, further comprising wireless transmitter circuitry to transmit the RF signal before receipt of the RF signal.

28. The compute device of claim 27, wherein to transmit the RF signal comprises to transmit the RF signal on the antenna.

29. The compute device of claim 27, wherein to transmit the RF signal comprises to transmit the RF signal on a second antenna different from the antenna.

30. The compute device of claim 27, wherein to transmit the RF signal comprises to transmit the RF signal as part of wireless communication with a remote device.

31. The compute device of claim 27, wherein the compute device comprises a bi-directional coupler coupled to the antenna,
wherein to receive the RF signal from the antenna comprises to receive, by the bi-directional coupler, a reflection of the transmitted RF signal from the antenna,
wherein to measure the transmitted RF signal comprises to couple the transmitted RF signal to the bi-directional coupler.

32. The compute device of claim 26, further comprising wireless transmitter circuitry to send a wireless beacon, wherein to receive the RF signal from the antenna comprises to receive the wireless beacon.

33. The compute device of claim 32, wherein to send the wireless beacon comprises to determine that a wireless signal suitable for determination of the indication of the angle of the lid portion has not been sent in a previous threshold amount of time.

34. The compute device of claim 26, wherein to determine the one or more parameters based on the RF signal comprises to demodulate the RF signal, wherein the one or more parameters comprise an in-phase and quadrature component of the demodulated RF signal.

35. The compute device of claim 34, further comprising wireless transmitter circuitry to transmit the RF signal before receipt of the RF signal,
wherein the wireless receiver circuity is to measure transmitted RF signal,
wherein the lid angle determiner circuitry is to determine one or more additional parameters based on the measured transmitted RF signal,
wherein to determine the indication of the angle of the lid portion relative to the base portion comprises to determine, based on the one or more parameters and the one or more additional parameters, the indication of the angle of the lid portion relative to the base portion,
wherein to determine the one or more additional parameters based on the measured transmitted RF signal comprises to demodulate the measured transmitted RF signal, wherein the one or more parameters comprise an in-phase and quadrature component of the demodulated measured transmitted RF signal.

36. The compute device of claim 34, wherein to determine the indication of the angle of the lid portion relative to the base portion comprises to determine, with use of a machine-learning-based algorithm, the indication of the angle of the lid portion relative to the base portion.

37. A method comprising:
receiving, by a compute device, a radiofrequency (RF) signal from an antenna of the compute device, wherein the compute device comprises a lid portion and a base portion;
determining, by the compute device, one or more parameters based on the RF signal; and
determining, by the compute device and based on the one or more parameters, an indication of an angle of the lid portion relative to the base portion.

38. The method of claim 37, further comprising transmitting, by the compute device, the RF signal before receipt of the RF signal.

39. The method of claim 38, further comprising:
measuring, by the compute device, the transmitted RF signal; and
determining, by the compute device, one or more additional parameters based on the measured transmitted RF signal,
wherein determining the indication of the angle of the lid portion relative to the base portion comprises determining, based on the one or more parameters and the one or more additional parameters, the indication of the angle of the lid portion relative to the base portion.

40. The method of claim 37, wherein determining the one or more parameters based on the RF signal comprises demodulating the RF signal, wherein the one or more parameters comprise an in-phase and quadrature component of the demodulated RF signal.

41. One or more non-transitory computer-readable media comprising a plurality of instructions stored thereon that, when executed, causes a compute device to:
receive a radiofrequency (RF) signal from an antenna of the compute device;
determine one or more parameters based on the RF signal; and
determine, based on the one or more parameters, an indication of an angle of a lid portion of the compute device relative to a base portion of the compute device.

42. The one or more non-transitory computer-readable media of claim 41, wherein the plurality of instructions further cause the compute device to transmit the RF signal before receipt of the RF signal.

43. The one or more non-transitory computer-readable media of claim 42, wherein the plurality of instructions further causes the compute device to measure the transmitted RF signal,
wherein the plurality of instructions further causes the compute device to determine one or more additional parameters based on the measured transmitted RF signal,
wherein to determine the indication of the angle of the lid portion relative to the base portion comprises to determine, based on the one or more parameters and the one or more additional parameters, the indication of the angle of the lid portion relative to the base portion.

44. The one or more non-transitory computer-readable media of claim 41, wherein to determine the one or more parameters based on the RF signal comprises to demodulate the RF signal, wherein the one or more parameters comprise an in-phase and quadrature component of the demodulated RF signal.

45. The one or more non-transitory computer-readable media of claim 44, wherein the plurality of instructions further cause the compute device to:
transmit the RF signal before receipt of the RF signal;
measure transmitted RF signal; and
determine one or more additional parameters based on the measured transmitted RF signal,
wherein to determine the indication of the angle of the lid portion relative to the base portion comprises to determine, based on the one or more parameters and the one or more additional parameters, the indication of the angle of the lid portion relative to the base portion, wherein to determine the one or more additional parameters based on the measured transmitted RF signal comprises to demodulate the measured transmitted RF signal, wherein the one or more parameters comprise an in-phase and quadrature component of the demodulated measured transmitted RF signal.
